(19) United States
(12) Patent Application Publication
(10) Pub. No.: US 2012/0206401 A1
(43) Pub. Date: Aug. 16, 2012

(54) HYBRID TOUCH PANEL DEVICE

(75) Inventors: JAOCHING LIN, TAIPEI CITY (TW); LINABEL CHU, TAIPEI CITY (TW); CHUNG-YI SHEN, TAIPEI CITY (TW); WEN-TING LEE, NEW TAIPEI CITY (TW)

(73) Assignee: HOWAY CORP., KAOHSIUNG CITY (TW)

(21) Appl. No.: 13/355,597

(22) Filed: Jan. 23, 2012

(30) Foreign Application Priority Data
Feb. 15, 2011 (TW) 100202769

(51) Int. Cl. G06F 3/044; G06F 3/045

(52) U.S. Cl. 345/174

(57) ABSTRACT

A hybrid touch panel device includes a resistive touch panel and capacitive touch sensing panel having a single sensing electrode pattern. The resistive touch panel is operable to generate a press position signal in response to pressure detected thereby. The capacitive touch sensing panel is disposed on top of the resistive touch panel and is operable to generate a touch position signal in response to at least one touch action detected thereby.

### CROSS-REFERENCE TO RELATED APPLICATION

This application claims priority of Taiwanese application No. 100202769, filed on Feb. 15, 2011.

### BACKGROUND OF THE INVENTION

1. Field of the Invention

This invention relates to a touch panel device, more particularly to a hybrid touch panel device.

2. Description of the Related Art

Resistive and capacitive touch panels are common touch sensing technology for detecting the position of a press or touch action.

Resistive touch panels are capable of providing precise single point detection when a press action is applied. However, as a result of nature of resistive touch panels, users need to exert a relative large force on the resistive touch panel by a stylus or a fingertip to perform detection of movement of an object or a finger.

Although capacitive touch panels are able to detect movement of an object or a finger, a position of a touch action cannot be detected precisely as a result of environmental influence.

As shown in FIGS. 1 and 2, Taiwanese Utility Model No. M321553 discloses a conventional touch panel device which comprises a resistive touch panel 4 and a capacitive touch panel 3 stacked on the resistive touch panel 4. The capacitive touch panel 3 includes a first electrode layer 31 and a second electrode layer 32 intersecting the first electrode layer 31 for generating X-Y coordinate data of a touch position detected thereby. However, such a touch panel device is relatively thick, thereby affecting adversely the transparency of the touch panel device. Additionally, manufacturing cost of an electronic device to which the touch panel device is applied is increased as well.

### SUMMARY OF THE INVENTION

Therefore, the object of the present invention is to provide a hybrid touch panel device capable of avoiding the above drawbacks of the prior art . According to this invention, a hybrid touch panel device comprises a resistive touch panel and a capacitive touch sensing panel. The resistive touch panel is operable to generate a press position signal in response to pressure detected thereby. The capacitive touch sensing panel is disposed on top of the resistive touch panel and is operable to generate a touch position signal in response to at least one touch action detected thereby.

Preferably, the resistive touch panel includes, from bottom to top, a substrate, a first conductor layer, a spacer layer, a second conductor layer, and an insulating layer, which are arranged in a stack, the capacitive touch sensing panel being stacked on top of the insulating layer of the resistive touch panel.

Preferably, the capacitive touch sensing panel includes a substrate disposed on top of the resistive touch panel, a protective layer disposed above the substrate, and a single sensing electrode pattern formed between the substrate and the protective layer.

Preferably, the substrate is an antioxidant layer.

Preferably, the hybrid touch panel device further comprising a controller electrically coupled to the resistive touch panel and the capacitive touch sensing panel to receive the press position signal and the touch position signal therefrom, and operable to generate a control signal based on at least one of the press position signal and the touch position signal.

Preferably, the protective layer is made of a material selected from the group consisting of glass, polymethylmethacrylate (PMMA), and polyethylene terephthalate (PET) plastic film.

Preferably, the capacitive touch sensing panel further includes a plurality of conductive traces for electrically connecting the electrodes to the controller so as to transmit the touch position signal to the controller, the electrodes extending in a first direction and being arranged in pairs in a second direction transverse to the first direction, the electrodes in each of the pairs being symmetric in shape.

Preferably, the controller measures the variance in the capacitances in the first direction to obtain a first component of the touch position signal, and measures the variance in the capacitances in the second direction to obtain a second component of the touch position signal.

Preferably, the electrodes extend in a first direction, are arranged in a second direction transverse to the first direction, and have width dimensions that vary along the first direction.

The hybrid touch panel device performs precise single point detection and detection for movement of the object or fingers. The capacitive touch sensing panel having the single sensing electrode pattern is relatively thin and has better transparency. Additionally, a simpler manufacturing process and a lower manufacturing cost may be achieved by the present invention.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic sectional view of a conventional touch panel device;

FIG. 2 is a schematic top view of the conventional touch panel device, illustrating a capacitive touch panel thereof as having two layers of sensing electrodes;

FIG. 3 is a schematic diagram of a hybrid touch panel device of a preferred embodiment according to the present invention, illustrating a capacitive touch sensing panel disposed on top of a resistive touch panel;

FIG. 4 is a schematic diagram of the preferred embodiment, illustrating configuration of the resistive touch panel;

FIG. 5 illustrates a transparent single sensing electrode pattern of the capacitive touch sensing panel of the preferred embodiment, in which the electrode pattern is composed of a plurality of triangular sensing electrodes;

FIG. 6 illustrates another aspect of the electrode pattern of the preferred embodiment, in which the electrode pattern is composed of a plurality of elongated electrodes and a plurality of triangular electrodes;

FIG. 7 illustrates still another aspect of the electrode pattern of the preferred embodiment, in which the electrode pattern is composed of a plurality of comb-like sensing electrodes;

FIG. 8 is similar to FIG. 5, but illustrating every two of the sensing electrodes that are spaced apart from each other by two of the sensing electrodes being connected by a conductive trace;

FIG. 9 illustrates still another aspect of the electrode pattern of the preferred embodiment, in which the electrode pattern is composed of a plurality of rows of sensing electrodes;

FIG. 10 illustrates still another aspect of the electrode pattern of the preferred embodiment; and

FIG. 11 illustrates still another aspect of the electrode pattern of the preferred embodiment, in which the electrode pattern is composed of a plurality of wavy sensing electrodes.

### DETAILED DESCRIPTION OF THE PREFERRED EMBODIMENTS

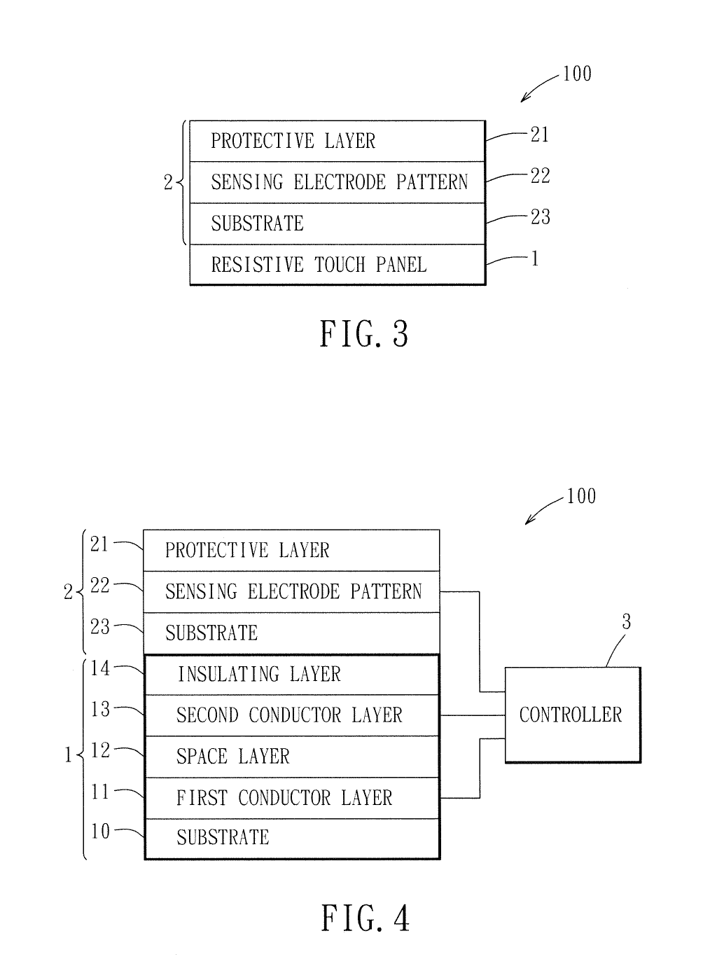

Referring to FIGS. 3 and 4, the preferred embodiment of a hybrid touch panel device 100 according to the present invention comprises a resistive touch panel 1, and a capacitive touch sensing panel 2 is disposed on top of the resistive touch panel 1 and is operable to generate a touch position signal in response to at least one touch action detected thereby. The controller 3 is electrically coupled to the resistive touch panel 1 and the capacitive touch sensing panel 2 to receive the press position signal and the touch position signal therefrom, and is operable to generate a control signal based on at least one of the press position signal and the touch position signal.

The resistive touch panel 1 includes, from bottom to top, a substrate 10, a first conductor layer 11, a spacer layer 12, a second conductor layer 13, and an insulating layer 14, which are arranged in a stack. The substrate 10 maybe a transparent substrate, and the first and second conductor layers 11, 13 are provided for generating the press position signal in response to the pressure detected by the resistive touch panel 1. In this embodiment, the resistive touch panel 1 is a commercially available resistive touch panel, such as four-wire, five-wire, and six-wire resistive touch panels.

The capacitive touch sensing panel 2 includes a substrate 23 stacked on top of the insulating layer 14 of the resistive touch panel 1, a protective layer 21 disposed above the substrate 23, and a single sensing electrode pattern 22 formed between the substrate 23 and the protective layer 21.

It should be noted that the protective layer 21 is made of a material selected from the group consisting of glass, polymethylmethacrylate (PMMA), and polyethylene terephthalate (PET) plastic film, and the substrate 23 may be an antioxidant layer in other embodiments of this invention.

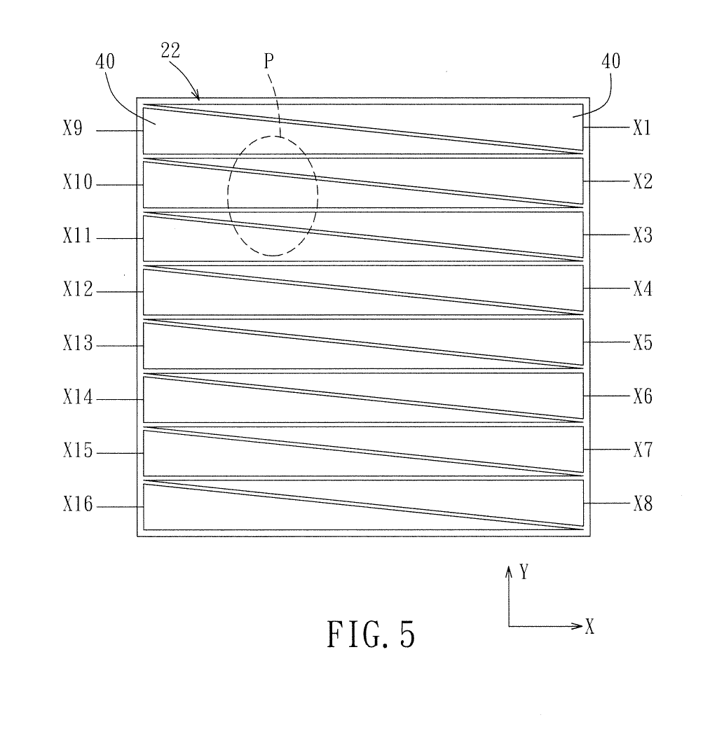

Further referring to FIG. 5, the single sensing electrode pattern 22 is formed by a plurality of electrodes 40 that are configured as right triangles. The electrodes 40 extend in a first direction (X) and are arranged in pairs in a second direction (Y) transverse to the first direction (X). Additionally, the electrodes 40 have width dimensions varying along the first direction (X). The electrodes 40 are electrically isolated from each other and have capacitances varying according to the at least one touch action (P) detected by the capacitive touch sensing panel 2.

The capacitive touch sensing panel 2 further includes a plurality of conductive traces X1-X16 for electrically connecting the electrodes 40 to the controller 3 so as to transmit the touch position signal to the controller 3. In this embodiment, the sensing electrode pattern 22 is a transparent indium tin oxide (ITO) pattern formed on the substrate 23.

The controller 3 measures the variance in the capacitances in the first direction (X), e.g., by interpolation, to obtain a first component of the touch position signal, and measures the variance in the capacitances in the second direction (Y) to obtain a second component of the touch position signal. Consequently, X-Y coordinate data of the press and touch action detected by the resistive touch panel 1 and the capacitive touch sensing panel 2 can be obtained.

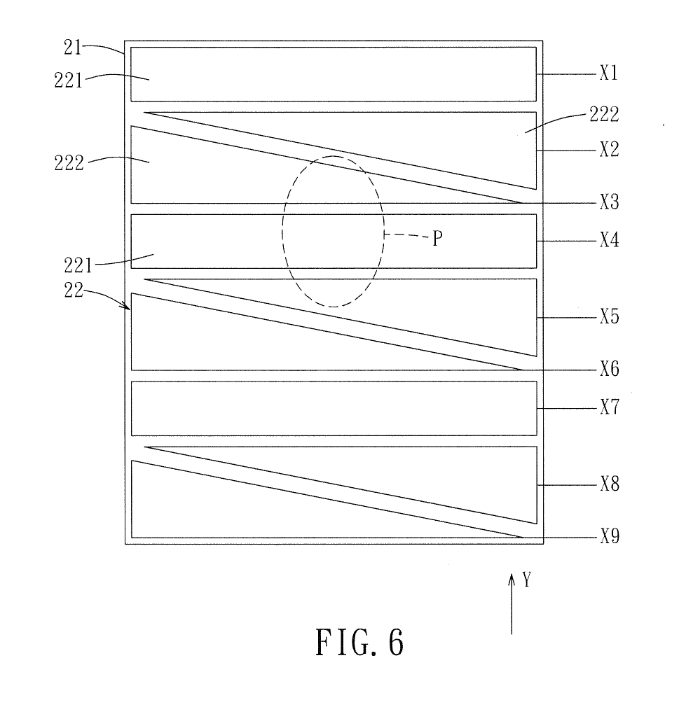

Referring to FIG. 6, a modified single sensing electrode pattern 22 is composed of a plurality of elongated electrodes 221 and a plurality of triangular electrodes 222 arranged in pairs in the second direction (Y). Each pair of the triangular electrodes 222 alternates with each of the elongated electrodes 221 in the second direction (Y). The capacitive touch sensing panel 2 includes a plurality of conductive traces X1-X9 that electrically connect the electrodes 221, 222 to the controller 3 so as to transmit the touch position signal to the controller 3 in response to the touch action (P) detected by the capacitive touch sensing panel 2. Subsequently, the controller 3 (see FIG. 4) measures the variance in the capacitances of the electrodes 221, 222 in the first and second directions (X, Y) so as to obtain X-Y coordinate data of the touch action (P).

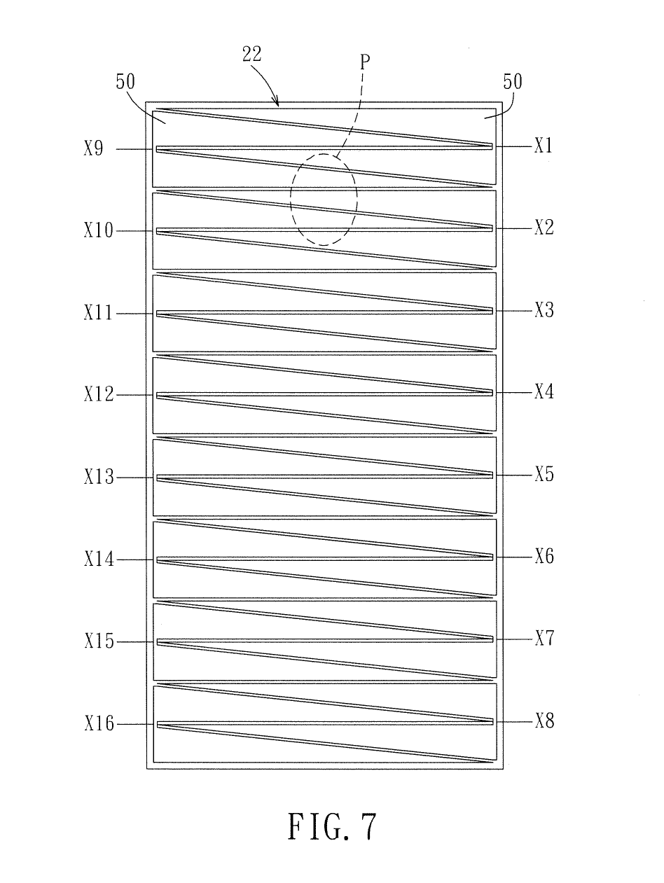

Referring to FIG. 7, another modified single sensing electrode pattern 22 is shown to include a plurality of comb-like electrodes 50 that are electrically connected to the controller 3 by the conductive traces X1-X16, respectively. The X-Y coordinate data of the touch action (P) is also obtained by the controller 3 in the same manner as described above.

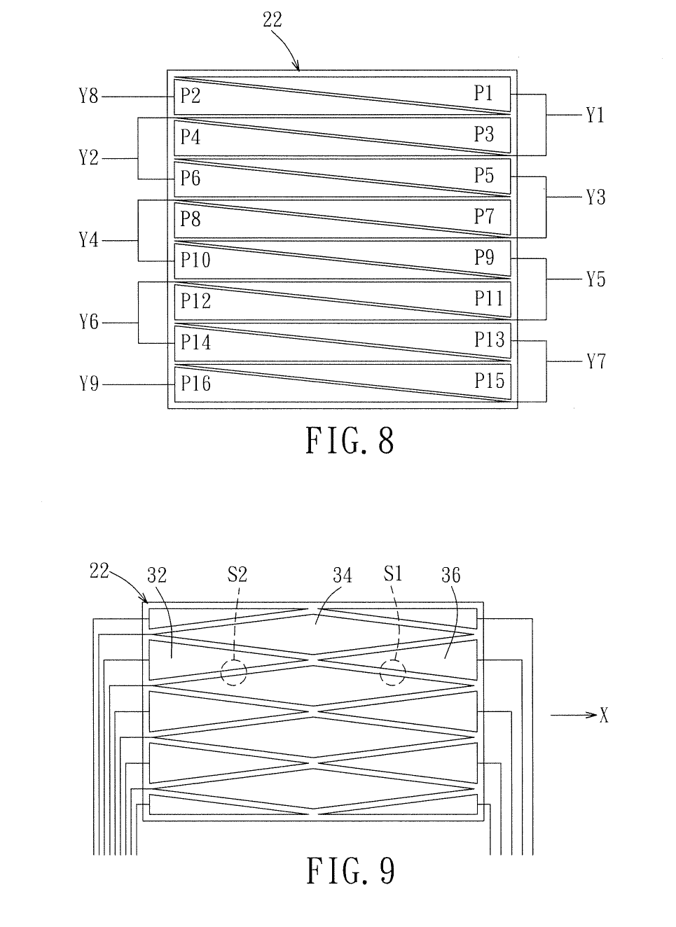

Referring to FIG. 8, a modified sensing electrode pattern 22 is composed of a plurality of triangular electrodes P1-P16 and the capacitive touch sensing panel 2 includes a plurality of conductive traces Y1-Y9. Every two of the sensing electrodes P1-P16 that are spaced apart from each other by two of the sensing electrodes P1-P16 are connected to the controller 3 by one of the conductive traces Y1-Y9. The sensing electrodes P1 and P4 are in parallel connection and are connected to the controller 3 by one of the conductive traces Y1, the sensing electrodes P3 and P6 are in parallel connection and are connected to the controller 3 by one of the conductive traces Y2, the sensing electrodes P5 and P8 are in parallel connection and are connected to the controller 3 by one of the conductive traces Y3, and so forth. The sensing electrodes P2 and P16 are connected to the controller 3 by the conductive traces Y8 and Y9, respectively.

Furthermore, referring to FIG. 9, the single sensing electrode pattern 22 may be configured to include a plurality of rows of electrodes 32, 34, 36. Each row of the electrodes 32, 34, 36 includes three electrodes 32, 34, 36 that are arranged in the first direction (X) and that are isolated from one another. Particularly, each of the electrodes 32, 36 is generally triangular-shaped, and each of the electrodes 34 is generally rhombus-shaped and is surrounded by two adjacent pairs of the electrodes 32, 36.

Consequently, the capacitive touch sensing panel 2 can detect two touch actions (S1, S2) arranged in the first direction (X) at the same time.

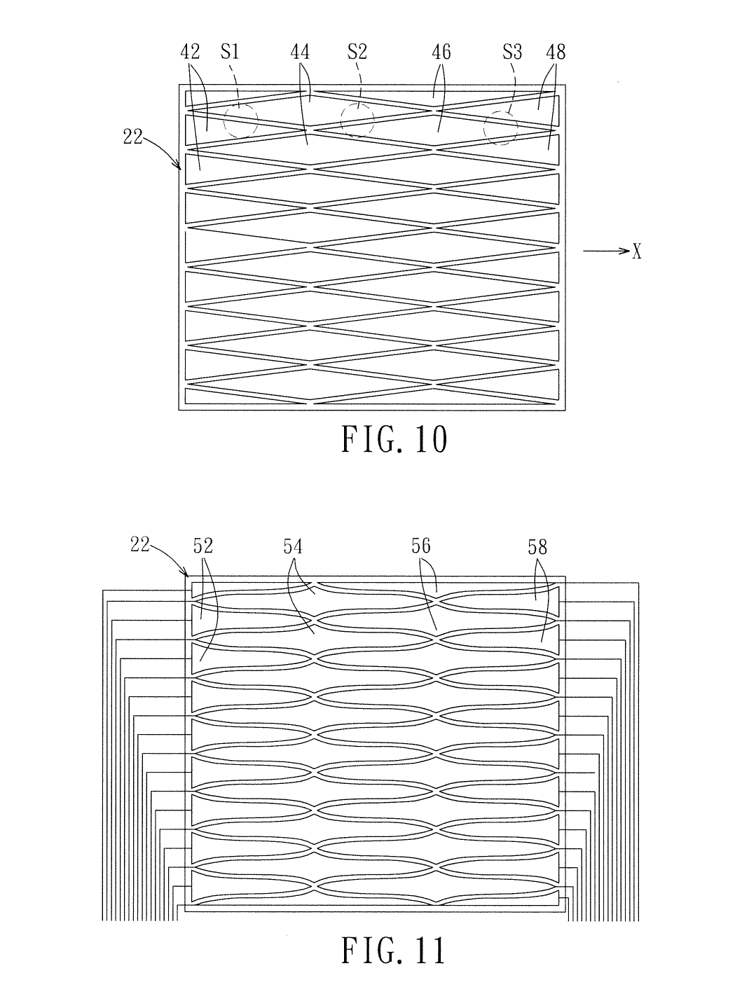

Similarly, referring to FIG. 10, the single sensing electrode pattern 22 may be configured to include a plurality of rows of electrodes 42, 44, 46, 48. Particularly, the electrodes 44, 46 are generally rhombus-shaped and are alternately arranged with one another, and the electrodes 42, 48 are generally triangular-shaped. Each row of the electrodes 42, 44, 46, 48 includes four electrodes 42, 44, 46, 48 that are arranged in the first direction (X) and that are isolated from one another. Accordingly, three touch actions (S1, S2, S3) arranged in the first direction (X) can be detected at the same time. Additionally, referring to FIG. 11, the single sensing electrode pattern 22 may be composed of a plurality of wavy electrodes 52, 54, 56, 58.

It should be noted that the electronic device to which the touch panel device 100 is applied can be designed to respond to one of the press position signal and the touch position signal based on user selection.

To sum up, the advantages of the hybrid touch panel device 100 of the present invention are as follows:

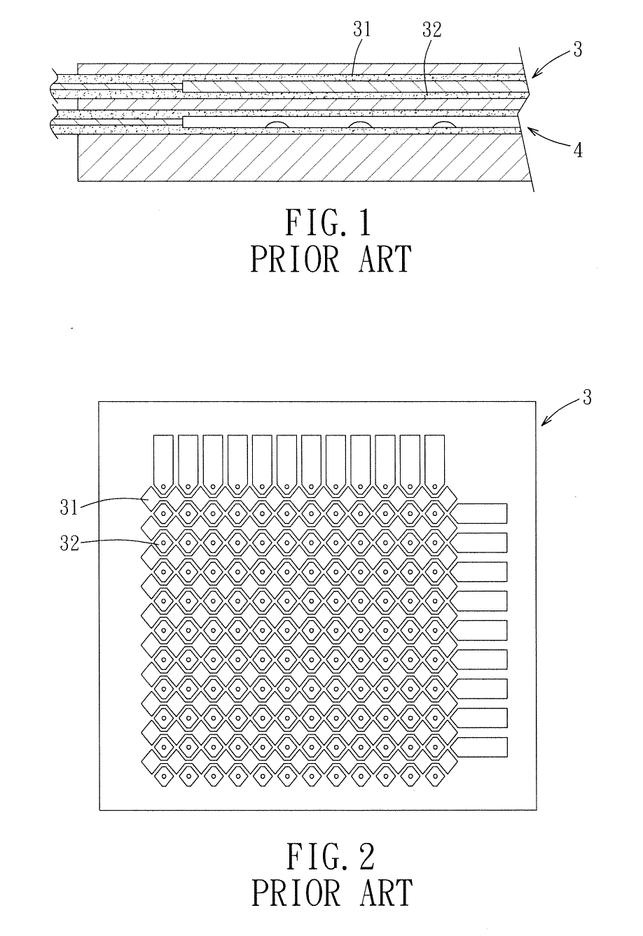

The hybrid touch panel device 100 may perform precise single point detection and detection for movement of the object or fingers. Compared to the conventional touch panel device illustrated in FIGS. 1 and 2, the capacitive touch sensing panel 2 having the single sensing electrode pattern is thinner and has better transparency. Additionally, a simpler manufacturing process and a lower manufacturing cost may be achieved by the present invention.

While the present invention has been described in connection with what is considered the most practical and preferred embodiments, it is understood that this invention is not limited to the disclosed embodiment but is intended to cover various arrangements included within the spirit and scope of the broadest interpretations and equivalent arrangements.

What is claimed is:

1. A hybrid touch panel device comprising:
a resistive touch panel operable to generate a press position signal in response to pressure detected thereby; and
a capacitive touch sensing panel disposed on top of said resistive touch panel, including a single sensing electrode pattern, and operable to generate a touch position signal in response to at least one touch action detected thereby.

2. The hybrid touch panel device as claimed in claim 1, wherein said resistive touch panel includes, from bottom to top, a substrate, a first conductor layer, a spacer layer, a second conductor layer, and an insulating layer, which are arranged in a stack, said capacitive touch sensing panel being stacked on top of said insulating layer of said resistive touch panel.

3. The hybrid touch panel device as claimed in claim 1, wherein said capacitive touch sensing panel includes a substrate disposed on top of said resistive touch panel, and a protective layer disposed above said substrate, said single sensing electrode pattern of said capacitive touch sensing panel being formed between said substrate and said protective layer.

4. The hybrid touch panel device as claimed in claim 3, wherein said sensing electrode pattern includes a plurality of electrodes which are electrically isolated from each other and which have capacitances that vary according to the at least one touch action detected by said capacitive touch sensing panel.

5. The hybrid touch panel device as claimed in claim 3, wherein said protective layer is made of a material selected from the group consisting of glass, polymethylmethacrylate (PMMA), and polyethylene terephthalate (PET) plastic film.

6. The hybrid touch panel device as claimed in claim 3, wherein said substrate is an antioxidant layer.

7. The hybrid touch panel device as claimed in claim 4, further comprising a controller electrically coupled to said resistive touch panel and said capacitive touch sensing panel to receive the press position signal and the touch position signal therefrom, and operable to generate a control signal based on at least one of the press position signal and the touch position signal.

8. The hybrid touch panel device as claimed in claim 7, wherein said capacitive touch sensing panel further includes a plurality of conductive traces for electrically connecting said electrodes to said controller so as to transmit the touch position signal to said controller, said electrodes extending in a first direction and being arranged in pairs in a second direction transverse to the first direction, said electrodes in each of said pairs being symmetric in shape.

9. The hybrid touch panel device as claimed in claim 8, wherein said controller measures the variance in the capacitances in the first direction to obtain a first component of the touch position signal, and measures the variance in the capacitances in the second direction to obtain a second component of the touch position signal.

10. The hybrid touch panel device as claimed in claim 7, wherein said electrodes extend in a first direction, are arranged in a second direction transverse to the first direction, and have width dimensions that vary along the first direction.
